(19) United States
(12) Patent Application Publication
(10) Pub. No.: US 2002/0197404 A1
(43) Pub. Date: Dec. 26, 2002

(54) Method of activating non-conductive substrate for use in electroless deposition

(75) Inventors: Chien-Liang Lee, Hsinchu (TW); Chi-Chao Wan, Taipei (TW)

Correspondence Address: EDWARDS & ANGELL, LLP, P.O. Box 9169, Boston, MA, 02209, US

(73) Assignee: Chang Chun Plastics Co., Ltd., Taiwan R.O.C.

(21) Appl. No.: 10/120,948

(22) Filed: Apr. 11, 2002

(30) Foreign Application Priority Data
Apr. 12, 2001 (TW) 90108729

(51) Int. Cl. B05D 3/10

(52) U.S. Cl. 427/306

(57) ABSTRACT

A method of activating a non-conductive substrate for use in electroless deposition is proposed, in which an aqueous solution containing nanoparticles of noble metals and their alloys is used as an activation solution in an electroless plating process, so as to electrolessly deposit a conductive metal deposition on the substrate and into micrometer-sized trenches formed on the substrate. By using this method with provision of a solution of a copper or nickel salt, copper or nickel can be deposited on the non-conductive substrate, allowing high aspect-ratio trenches on the substrate to be filled with copper or nickel for subsequent use in fabrication of integrated circuit interconnection.

### FIELD OF INVENTION

The present invention relates to methods of activating non-conductive substrates for use in subsequent electroless plating processes, and more particularly, to a method for performing electroless metal deposition on a non-conductive substrate, with an aqueous solution containing nanoparticles of noble metals and their alloys being used as an activation solution during electroless deposition. This method can be widely applied in a manufacturing process of electronic circuits, e.g. a PTH (plating through hole) process in fabrication of printed circuit boards and a process for fabricating very large-scale copper integrated circuit interconnection.

### BACKGROUND OF THE INVENTION

Electroless deposition of a good conductive metal such as copper, nickel, gold or the like on a non-conductive or poor conductive substrate has been the most important technique in a manufacturing process of electronic circuits. Electroless deposition is characterized in reduction of metal ions on an activated substrate surface by using a reducing agent, and includes sensitizing and activation steps. First, as early disclosed in the art, the sensitizing step is to immerse a substrate in an acidic stannous chloride (SnCl₂) solution; then, in the activation step, the substrate is subsequently immersed in an acidic palladium chloride (PdCl₂) solution. The activated substrate then oxidizes a reducing agent such as formaldehyde in an electroless metal complex solution, so as to allow metal ions contained in the solution to be chemically reduced and deposited on the substrate, as disclosed in U.S. Pat. No. 4,082,899. As time goes on, electroless deposition has been evolved from the two-step (sensitizing/activation) process to a single activation step, the latter which becomes a mainstream in industrial application. Consequently, preparation of activation solutions increasingly plays an important role in electroless deposition. Generally, an activation solution used in the single activation step comprises noble metal alloys or pure metal colloids with particle diameters larger than 20 nm. These colloids are suspended and dispersed in the solution, and capable of catalyzing reduction deposition of metal ions, thereby having an activation function. However, these colloidal particles tend to agglomerate and precipitate in the solution; therefore, how to effectively disperse colloidal particles in an activation solution for increasing lifetime of the activation solution and reducing production costs, is a critical problem to solve in electroless deposition application.

Various activation solutions used in industry are exemplified as follows, which solutions are made based on similar basic principles and provide similar effects as the one described above.

(1) As described in U.S. Pat. No. 4,593,016, palladium chloride and stannous chloride are respectively dissolved in separate aqueous solutions of hydrochloric acid. The two solutions are mixed and temperature is raised to 100° C., so as to reduce palladium ions by virtue of oxidation of stannous ions thereby forming an electroless plating activation solution containing tin-palladium alloy colloids. Then, a polymeric substrate is immersed in the activation solution of tin-palladium alloy colloids for proceeding substrate activation. Subsequently, the activated substrate is immersed in an electroless copper solution for carrying out an electroless plating process, so that copper can be deposited on the substrate.

(2) As described in U.S. Pat. No. 5,009,965, CnCl₂, Sn(BF₄)₂, Gelatin, NaBH₄, and NaOH are added into deionized water to form an electroless plating activation solution containing copper-tin alloy colloids while using NaBH₄ as a reducing agent. An alumina ceramic substrate is immersed in the activation solution of copper-tin alloy colloids for proceeding substrate activation. Subsequently, the activated substrate is immersed in a commercially-available electroless copper solution (Enplate 404), so as to carry out an electroless plating process and deposit copper on the substrate.

(3) As described in U.S. Pat. No. 4,082,557, AgNO₃, NaBH₄, and decahydrate are added into deionized water to form an activation solution containing silver colloids while using NaBH₄ as a reducing agent. A substrate is then immersed in the activation solution and activated. Subsequently, the activated substrate is immersed in an electroless copper solution, in which an electroless plating process takes place, allowing copper to be deposited on the substrate.

(4) As described in U.S. Pat. No. 5,165,971, a palladium complex is formed by dissolving PdCl₂ and 1-(3-sulfopropyl)-2-pyridine in deionized water, which palladium complex is then added with ethanol while raising temperature to 50° C., so as to form an electroless plating activation solution containing palladium colloids.

(5) As described in U.S. Pat. No. 4,568,570, a carbon fabric substrate is firstly immersed in an aqueous solution of a silver-containing amine complex at 90° C., and then immersed in an electroless nickel solution for performing an electroless nickel plating process, so as to deposit nickel on the substrate.

(6) As described in U.S. Pat. No. 5,989,787, aqueous solutions of zinc lactate, copper lactate and palladium chloride are mixed and applied onto an aluminum substrate, which substrate is then exposed to high-power ultra-violet rays, thereby forming alloy colloids by means of reduction. Subsequently, the substrate is immersed in an electroless nickel solution where an electroless nickel plating process is carried out.

(7) As described in U.S. Pat. No. 4,661,384, an aqueous solution of Na₂PdCl₄ and a CH₂Cl₂ solution of cyclic crown ether are mixed to form a palladium complex activation solution. A substrate is then immersed in the activation solution and activated. Next, the activated substrate is immersed in an electroless nickel solution, so as to carry out an electroless plating process and deposit nickel on the substrate.

(8) As described in U.S. Pat. No. 5,874,125, a palladium salt and a copper salt are dissolved into an aqueous solution and mixed together, to which ammonia and polyvinyl alcohol (PVA) are added. The substrate is then applied with a metal salt solution thereon, and irradiated with high-power ultra-violet rays, whereby alloy colloids are formed by reduction. Subsequently, an electroless nickel plating process is carried out by immersing the substrate into an electroless nickel solution.

(9) As described in U.S. Pat. No. 4,753,821, a ABS substrate is immersed into an aqueous solution of a silver-containing amine complex, and then exposed to a high-pressure mercury lamp. Next, the substrate is immersed in an electroless nickel solution for proceeding an electroless nickel plating process.

(10) As described in U.S. Pat. No. 4,004,051, a noble metal salt is dissolved in an aqueous solution, to which NaBH₄ is added for reducing metal ions in the form of complex, thereby form a colloid-containing electroless plating activation solution.

As a palladium-containing activation solution currently used in industry contains a large amount of tin compounds that are adsorbed onto surfaces of palladium catalysts for maintaining catalyst suspension stability, thus after activating a substrate, it needs to perform a complicated process or removing the adsorbed tin compounds from the activated substrate. Further, tin-palladium alloy colloids are relatively larger in particle diameter, and easily agglomerate to precipitate; this would deactivate the activation solution, thereby leading to increasing in production costs.

### SUMMARY OF THE INVENTION

A primary objective of the present invention to provide a method of activating a non-conductive substrate for use in electroless deposition in which an activation solution containing nanoparticles of noble metals and their alloys is adopted in an electroless plating process. The substrate activation method of the invention characterized of using an activation solution containing palladium or platinum nanoparticles, provides significant advantages as follows. First, the electroless plating process is simply implemented without producing undesirable tin compounds, and is therefore different from the one applied in industry of manufacturing electronic circuits. Second, the activation solution is easily prepared. Third particles contained in the activation solution have high stability and are capable of being effectively dispersed in an aqueous solution for a long term

### BRIEF DESCRIPTION OF THE DRAWINGS

The present invention can be more fully understood by reading the following detailed description of the preferred embodiments, with reference made to the accompanying drawings, wherein:

FIG. 1 is a TEM (transmission electron microscope) image of an electroless activation solution containing palladium nanoparticles (amplification is 25×10⁴ times, e.g. 0.5 cm in the drawing is equal to 20 nm in real case);

FIG. 2 is a photo showing an epoxy resin substrate surface after being cut-dimensioned and washed, after being activated, and after being electrolessly deposited with copper, respectively from left to right in the drawing;

FIG. 3 is a photo showing an epoxy resin substrate surface after being cut-dimensioned and washed, after being activated, and after being electrolessly deposited with nickel, respectively from left to right in the drawing; and

FIG. 4 is a SEM (scanning electron microscope) image of a TaN substrate with micrometer-scale trenches being electrolessly deposited with copper.

### DETAILED DESCRIPTION OF THE PREFERRED EMBODIMENTS

A method of activating a non-conductive substrate for use in electroless deposition of the present invention is characterized of using an activation solution containing nanoparticles of noble metals and their alloys with particle diameters from 1 to 20 nm in an electroless plating process. It is found that, with the use of a noble metal salt solution and a specific surfactant exclusive of a reducing agent, noble metal ions can be successfully reduced into metal nanoparticles by virtue of the surfactant reducibility (under patentability application). It has been reported that nanoparticles of noble metals have catalytic activity for electroless plating (Hamilton J. F.; Baetzold R. C., Science, 1979, 205, 1213), in which platinum nanoparticles are used as activation catalysts in an electroless nickel plating process; however, platinum nanoparticles fabricated by vapor deposition cannot be produced in a large scale, thereby lacking commercial application values.

The activation solution containing nanoparticles of the invention for use in the electroless plating process, is prepared by mixing an aqueous solution of noble metal salt with an aqueous solution of a surfactant containing sulfate ions (SO₄²⁻). The electroless plating process comprises the following steps of: rinsing a substrate with water; activating the substrate with an activation solution containing nanoparticles of noble metals and their alloys; rinsing the substrate with water; performing electroless deposition on the substrate; and rinsing the substrate with water.

### PREFERRED EMBODIMENTS

### EXAMPLE 1

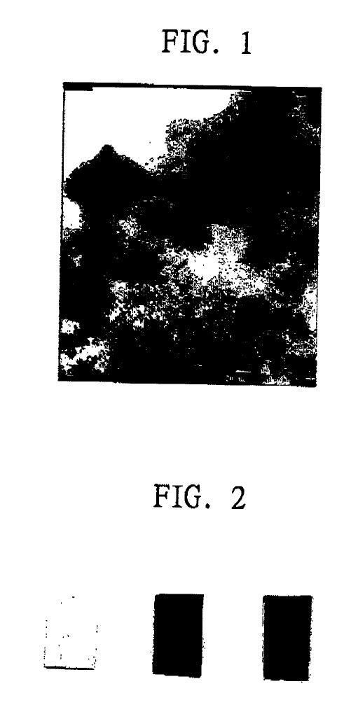

In Example 1, an epoxy resin substance is activated with the use of an activation solution containing palladium nanoparticles, followed by electroless plating for copper deposition on the substrate. An epoxy resin substrate (surface area of 2 cm×1 cm) is immersed in an activation solution containing palladium nanoparticles for 10 minutes at 50° C. FIG. 1 shows a TEM image of an activation solution containing palladium nanoparticles with an average particle diameter of 3.36 nm. The activation solution containing palladium nanoparticles has the following composition:

| | | |
|---|---|---|
| palladium acetate (Pd(OAc)₂) | 0.4 | g |
| sodium dodecylsulphate (SDS) | 2.88 | g |
| deionized water | 100 | ml |

After being rinsed with water, the substrate is immersed into an electroless copper solution (pH=11.8˜12.2) for 10 minutes, where an electroless plating process is carried out for allowing copper to be deposited on the epoxy resin substrate. The electroless copper solution has the following composition:

| | | |
|---|---|---|
| CuSO₄ · 5H₂O | 12.5 | g/l |
| EDTA | 37.5 | g/l |
| NaOH | 14 | g/l |
| C₅H₅N | 100 | ppm/l |
| HCHO | 6 | ml/l |

The epoxy resin substrate activated by palladium nanoparticles can be successfully deposited with copper thereon as shown in FIG. 2, which illustrates the appearance of the epoxy resin substrate surface after being cut-dimensioned and washed, after being activated, and after being electrolessly deposited with copper, respectively from left to right in the drawing.

### EXAMPLE 2

In Example 2, an epoxy resin substrate is activated with the use of an activation solution containing palladium nanoparticles, and then subjected to an electroless plating process in an alkaline electroless nickel solution, so as to allow nickel to be deposited on the activated substrate. An epoxy resin substrate (surface area of 2 cm×1 cm) is immersed in an activation solution containing palladium nanoparticles for 10 minutes at 50° C. The activation solution containing palladium nanoparticles has the following composition:

| | |
|---|---|
| palladium chloride (PdCl₂) | 0.08 g |
| sodium dodecylsulphate (SDS) | 2.88 g |
| deionized water | 100 ml |

After being rinsed with water, the substrate is immersed into an electroless nickel solution (pH=8) for 10 minutes to effect electroless plating for depositing nickel on the epoxy resin substrate. The electroless nickel solution has the following composition:

| | |
|---|---|
| nickel chloride | 0.1 M |
| sodium citrate | 0.15 M |
| sodium hypophosphite | 0.093 M |
| triethanolamine | 0.15 M |

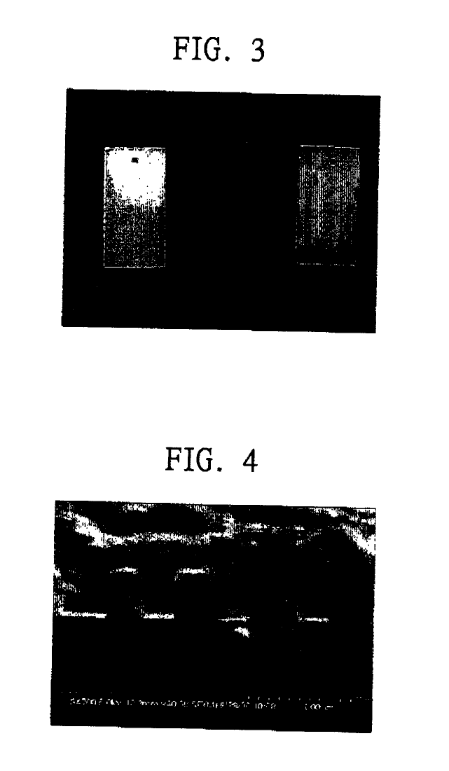

The epoxy resin substrate activated by the palladium nanoparticles can be successfully deposited with nickel thereon, as shown in FIG. 3, which illustrates the appearance of the epoxy resin substrate surface after being cut-dimensioned and washed, after being activated, and after being electrolessly deposited with nickel, respectively from left to right in the drawing.

### EXAMPLE 3

In Example 3, an epoxy resin substrate is activated with the use of an activation solution containing palladium nanoparticles. An electroless plating process is then carried out in an acidic electroless nickel solution so as to deposit nickel on the substrate. An epoxy resin substrate (surface area of 2 cm×1 cm) is immersed in an activation solution containing palladium nanoparticles or 10 minutes at 50° C. The activation solution containing palladium nanoparticles has the following composition:

| | |
|---|---|
| palladium acetate (Pd(OAc)₂) | 0.02 g |
| sodium dodecylsulphate (SDS) | 2.88 g |
| deionized water | 100 ml |

After being rinsed with water, the substrate is immersed into an electroless nickel solution (pH=5.35, temperature of 80 to 85° C.) for 10 minutes, where an electroless nickel plating is carried out for depositing nickel on the epoxy resin substrate. The electroless nickel solution has the following composition:

| | |
|---|---|
| nickel chloride | 0.1 M |
| sodium citrate | 0.15 M |
| sodium hypophosphite | 0.093 M |

### EXAMPLE 4

In fabrication of copper interconnection of integrated circuits, a copper film serving as a seed layer for subsequent electroplating is deposited on a barrier layer made of TaN, Ta, TiN or Ti by using an electroless plating process. In Example 4, a TaN substrate (surface area of 2 cm×1 cm) for use in integrated circuit manufacture, is activated with the use of an activation solution containing palladium nanoparticles. An electroless plating process is then carried out, and copper is deposited on the TaN substrate and fills micrometer-sized interconnection trenches formed on the substrate. The activation process and compositions of an activation solution and an electroless copper solution used herein are identical to those in Example 1. The TaN substrate with micrometer-sized interconnection trenches is activated by using the activation solution, and can be successfully deposited with copper thereon as shown in FIG. 4, which illustrates a SEM image of the TaN substrate after being electrolessly plated with copper in a manner that copper is successfully deposited on the TaN substrate and fills the micrometer-sized interconnection trenches.

### EXAMPLE 5

Noble metal nanoparticles contained in an electroless activation solution of the invention are not limited to palladium nanoparticles. In Example 5, an epoxy resin substrate is activated with the use of an activation solution containing platinum nanoparticles, and then electrolessly deposited with copper on the activated substrate. The activation solution used in this example is similar in composition to that in Example 1, except that 0.4 g Pd(OAc)₂ in Example 1 is substituted by 0.1 g H₂PtCl₆.H₂O herein. An epoxy resin substrate is immersed into the activation solution containing platinum nanoparticles for 10 minutes at 50° C. Subsequently, an electroless plating process is carried out for allowing copper to be deposited on the epoxy resin substrate.

### EXAMPLES 6-10

The method described in Example 1 is repeated, in which an epoxy resin substrate is replaced by various conventional polymeric substrates used for printed circuit boards, and an electroless copper plating process is performed for the polymeric substrates.

| | | Whether copper is |
|---|---|---|
| Example | Substrate | electrolessly deposited or not |
| 6 | polyimide substrate | Deposited |
| 7 | ABS substrate | Deposited |
| 8 | BGA substrate | Deposited |
| 9 | FR4 substrate | Deposited |
| 10 | polyester substrate | Deposited |

### EXAMPLES 11-15

| | | Whether copper is |
|---|---|---|
| Example | Substrate | electrolessly deposited or not |
| 11 | Ta | Deposited |
| 12 | TiN | Deposited |
| 13 | Ti | Deposited |
| 14 | Si | Deposited |
| 15 | SiO₂ | Deposited |

### EXAMPLES 16-20

Nanoparticles obtained in the invention have high activity capable of performing activation within a very wide range of concentrations. The method described in, Example 3 is repeated to carry out an acidic electroless nickel plating. Examples 16-20 are characterized of using various activation solutions containing different concentrations of palladium nanoparticles for activating an epoxy resin substrate, and then performing an acidic electroless nickel plating for the substrate. Results are shown in the following

| | | Activation | | Whether nickel is |
|---|---|---|---|---|
| | Amount of | temperature | Activation time | electrolessly |
| Example | Pd(OAc)₂ | (° C.) | (min) | deposited or not |
| 16 | 0.4 g | 50 | 10 | Deposited |
| 17 | 0.08 g | 50 | 10 | Deposited |
| 18 | 0.04 g | 50 | 10 | Deposited |
| 19 | 0.01 g | 50 | 10 | Deposited |
| 20 | 0.001 g | 50 | 10 | Deposited |

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A method of activating a non-conductive substrate for use in electroless deposition, in which an aqueous solution containing noble metal nanoparticles is used as an activation solution in an electroless plating process, so as to allow a conductive metal to be electrolessly deposited on the non-conductive substrate and filled into micrometer-sized trenches formed on the non-conductive substrate; the method comprising the steps of:
rinsing a non-conductive substrate with pure water;
activating the substrate with an activation solution containing nanoparticles of noble metals and their alloys;
rinsing the substrate with pure water;
performing an electroless plating process for the substrate; and
rinsing the substrate with pure water.

2. The method of claim 1, wherein the substrate is a non-conductive or poor conductive substrate with a flat surface or with micrometer-sized trenches thereon, including a substrate for use in integrated circuits, a non-conductive substrate, and a substrate for use in BGA semiconductor packages.

3. The method of claim 2, wherein the substrate for use in integrated circuits is made of a material selected from a group consisting of TaN, Ta, Ti, TiN, SiO₂ and Si.

4. The method of claim 2, wherein the non-conductive substrate is made of a material selected from a group consisting of ABS, polyimide, polyester and FR4.

5. The method of claim 1, wherein the activation solution is an aqueous solution containing nanoparticles of palladium, platinum or an alloy thereof.

6. The method of claim 5, wherein the palladium or platinum nanoparticles contained in the activation solution have particle diameters of 1 nm to 20 nm.

7. The method of claim 5, wherein the activation solution is formed by mixing an aqueous solution containing palladium salt or platinum salt with a surfactant or an aqueous solution of a water-soluble polymer.

8. The method of claim 7, wherein the surfactant is an anion surfactant having sulfate ions (SO₄²⁻), and has a concentration within a range of 0.01M to 1M.

9. The method of claim 7, wherein the water-soluble polymer includes polyvinyl alcohol (PVA), polyvinyl pyrrolidone (PVP) and polyacrylic acid (PAA), and has a concentration within a range of 0.01M to 1M.

10. The method of claim 7, wherein the platinum salt or palladium salt is a halide compound or an organic acid salt, and has a concentration within a range of 10 ppm to 10000 ppm.

11. The method of claim 1, wherein the deposited conductive metal is copper or nickel.
